(19) United States
(12) Patent Application Publication
(10) Pub. No.: US 2017/0139825 A1
(43) Pub. Date: May 18, 2017

(54) METHOD OF IMPROVING GARBAGE COLLECTION EFFICIENCY OF FLASH-ORIENTED FILE SYSTEMS USING A JOURNALING APPROACH

(71) Applicant: HGST Netherlands B.V., Amsterdam (NL)

(72) Inventors: Viacheslav Anatolyevic DUBEYKO, San Jose, CA (US); Cyril GUYOT, San Jose, CA (US)

(21) Appl. No.: 14/943,941

(22) Filed: Nov. 17, 2015

(51) Int. Cl. G06F 12/02

(52) U.S. Cl. CPC G06F 12/0253; G06F 12/0246; G06F 2212/1044; G06F 2212/2022; G06F 2212/7205

(57) ABSTRACT

A journaling approach is used to distribute cold and hot data between different areas of a segment's log on a physical erase block. The Main area of the log is used for cold data, and the Journal area is used for hot data. The Main area contains large, contiguous extents of rarely changed data (e.g., read-only data), and the Journal contains logical blocks of small and frequently updated data. An Updates area also contains updates that are pending. Data from the Main and Updates areas are accumulated and written to a Main area of a different segment's log during a garbage collection operation. The physical erase block is erased and added to a pool of clean physical erase blocks. Using a Journaling approach significantly simplifies the garbage collection process.

### CROSS REFERENCE TO RELATED APPLICATION

This application claims the benefit of the co-pending, commonly-owned US Patent Application with Attorney Docket No. HGST-H20151075US1, Ser. No. ______, filed on ______, by Dubeyko, et al., and titled “METHOD OF DECREASING WRITE AMPLIFICATION OF NAND FLASH USING A JOURNAL APPROACH”, and hereby incorporated by reference in its entirety.

This application claims the benefit of the co-pending, commonly-owned US Patent Application with Attorney Docket No. HGST-H20151076US1, Ser. No. ______, filed on ______, by Dubeyko, et al., and titled “METHOD OF DECREASING WRITE AMPLIFICATION FACTOR AND OVER-PROVISIONING OF NAND FLASH BY MEANS OF DIFF-ON-WRITE APPROACH”, and hereby incorporated by reference in its entirety.

### FIELD

Embodiments of the present invention generally relate to data storage systems. More specifically, embodiments of the present invention relate to systems and methods for improving garbage collection efficiency of flash-oriented file systems.

### BACKGROUND

Many flash-oriented file systems employ a log-structured scheme for writing data on file system volumes. Clean NAND flash pages can be written only once, so an entire NAND flash block must be erased before the page can be rewritten. As such, a copy-on-write policy is applied to any update of information already on the volume. A copy-on-write policy requires use of a garbage collector subsystem to clear and re-use invalid NAND flash blocks. Existing approaches to garbage collection are complex and inefficient due to inherent difficulties of selecting an optimal “victim” segment for garbage collection. Therefore, garbage collection activities for flash-oriented file systems typically degrade performance significantly.

Some existing garbage collection policies include timestamp policy, threshold-based policy, cost-benefit policy, and greedy policy. Each of these existing policies have well-known drawbacks. For example, the timestamp policy fails to account for segment utilization and may select segments with significant amount of valid blocks for clearing over invalid younger segments. The threshold-based policy is poorly suited for intensive latency-sensitive applications. The cost-benefit policy necessitates storing special metadata associated with segment ratings on a file system's volume, and further require special in-core structures (e.g., lists, trees, etc.) and sophisticated algorithms for supporting actual segment ratings in the background of file system operations. Greedy policy initiates significant amounts of block moving operations and result in performance degradation and an overall decrease of the lifetime of the flash-based storage system.

### SUMMARY

Methods and systems for managing data storage in flash memory devices are described herein. Embodiments of the present invention utilize approaches to garbage collection that increase efficiency of flash-oriented file systems.

According to one embodiment, a method of reusing an aged flash block in a flash-based storage system is disclosed. The method includes identifying a used physical erase block in a pool of physical erase blocks, determining an optimal physical erase block for garbage collection using predefined criteria, where the optimal physical erase block is a used physical erase block, reading a log of the optimal physical erase block, moving a first valid logical block from an updates area of the log to a different main area of a different log when the logical block has been updated and the updates area contains valid data, moving the first valid logical block from a main area of the log to the different main area of the different log when the logical block has not been updated and the main area contains valid data, and moving a second valid logical block from a journal area of the log to a different journal area of the different log when the journal area contains valid data.

According to another embodiment, an apparatus for reusing an aged flash block in a flash-based storage system is disclosed. The apparatus includes a flash memory device, a main memory, and a processor communicatively coupled to the flash memory device and the main memory that identifies a used physical erase block in a pool of physical erase blocks on the flash memory device, determines an optimal physical erase block to be reused based on predefined criteria, wherein the optimal physical erase block contains a used physical erase block, reads a log of the optimal physical erase block, moves a first valid logical block from an updates area of the log to a different main area of a different log when the logical block has been updated and the updates area contains valid data, moves the first valid logical block from a main area of the log to the different main area of the different log when the logical block has not been updated and the main area contains valid data, and moves a second valid logical block from a journal area of the log to a different journal area of the different log when the journal area comprises valid data.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts an exemplary segment's log comprising a Main Area, an Update Area, and a Journal Area for storing data and performing garbage collection according to embodiments of the present invention.

FIG. 2 depicts exemplary segment's logs for aggregating updates to a file and writing the content of the file with the updates to a Main area of a different segment's log according to embodiments of the present invention.

FIG. 3 depicts an exemplary segment's log for storing mixed-workload data with temporary files according to embodiments of the present invention.

FIG. 4 depicts an exemplary computer system for managing a flash-based storage system and performing garbage collection operations according to embodiments of the present invention.

FIG. 5 depicts an exemplary computer implemented process for performing garbage collection in a flash-based storage device according to embodiments of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

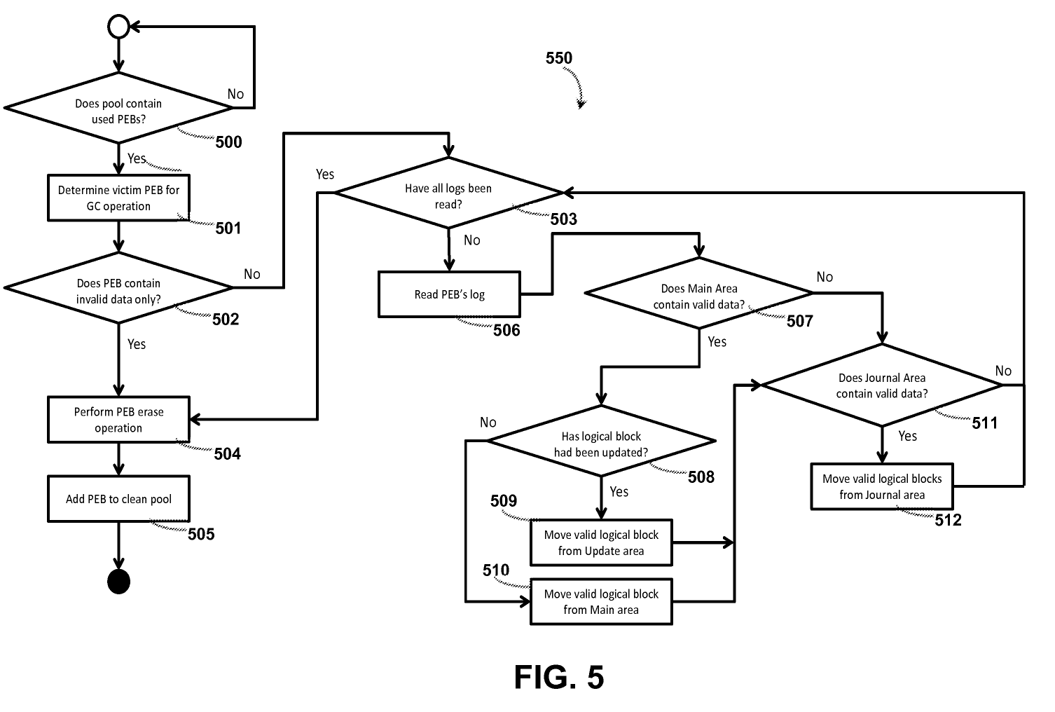

Portions of the detailed description that follows are presented and discussed in terms of a method. Although steps and sequencing thereof are disclosed in a figure herein (e.g., FIG. 5) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Improving Garbage Collection Efficiency of Flash-Oriented File Using a Journaling Approach

The following description is presented to enable a person skilled in the art to make and use the embodiments of this invention; it is presented in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

Flash-based storage devices (e.g., SSDs) featuring log-structured file systems use two fundamental concepts: a segment model for file system volumes and a Copy-on-Write approach for writing data to the volume. In a typical Copy-On-Write (COW) approach, every updated block is copied to a new location. As a result, user data is saved on a volume in the form of segment-based portions of user data and metadata referred to as logs. After a file that contains the NAND flash page has been deleted, the associated logical blocks are marked as invalid. The log-structured file system employs a special garbage collection subsystem for clearing aged NAND flash blocks that contain invalid pages for reuse. NAND flash pages with valid data of aged NAND flash block will be subsequently written to a different clean NAND flash block.

According to one embodiment of the present invention, user data stored on a file system volume is classified as “cold”, “warm”, or “hot” in regard to the frequency of updates associated with a given file. Specifically, cold data is basically unchanged during the lifetime of the data. In other words, cold data can essentially treated as “read-only” data because it is almost never changed or updated. Warm data is updated in small amounts more frequently than cold data. Hot data comprises the most frequently updated data on a file system volume.

A log-structured file system typically divides the file system's volume into chunks called segments. The segments have a fixed size and are a basic item for allocating free space on the file system volume. Each segment comprises one or more NAND flash blocks (e.g., erase blocks). User data is saved on the volume as a log, which is a segment-based portions of user data combined with metadata. Each erase block includes one or more logs. Based on the classification of data as “cold”, “warm”, and “hot” as discussed above, user data is distributed to three different conceptual areas of a log. According to some embodiments, a segment's log is conceptually divided into a “Main” area, an “Updates” area, and a “Journal” area. The Main area contains “cold” data that changes very rarely, if at all (e.g., read-only data). Updated blocks of the Main area are stored in the Updates area. The Journal area stores small files and temporary files. Temporary files will be deleted frequently and result in invalid blocks in Journal area. Several small files can be compacted together into one NAND flash page of the Journal area. These small files can grow in size over time. When the files grow beyond a certain size, updated small file should be moved into another log. As a result, this activity will invalidate blocks in Journal area of the previously used logs.

Cold and hot data are frequently mixed together in real-world workloads of multi-threaded applications, and this mixing of data further complicates garbage collection and degrades overall performance of file system operations on aged volumes. One exemplary mixed-data workload comprises a first thread saving a large video file on the volume while another thread operates using temporary files on the same physical erase block (PEB). Furthermore, the complex file structures of data files used by modern applications contain sophisticated metadata with encapsulated user data items that further complicate garbage collection activities. Logical blocks that contain metadata are updated more frequently than user data items, so these files can be represented as a sequence of cold data with areas of warm data that are updated occasionally. This significantly complicates garbage collection.

To overcome these issues, a journaling approach may be used to distribute cold and hot data between different areas of a log. The main area of the log is used for large extents of cold (e.g., read-only) data. The Updates area is be used for any updates of logical blocks in the Main area. The Journal area should be used for small files. A combination of several small files stored in one NAND flash page increase the update frequency in the Journal area, and storing temporary files in the Journal area results in a greater number of invalid logical blocks in the Journal area.

Another example of a mixed-data workload involves a word file comprising contiguous extents of data that can be updated occasionally. Initially the extents can be treated as cold data and only some of the logical blocks are updated with varying frequency. When stored within the contiguous extent is updated, the extent of data is divided into several smaller extents of data and written to a new place. This significantly complicates garbage collection and results in inefficiency. To overcome these issues, an updates area of a log may be used to store updates of logical blocks in the main area (cold data). The updates may comprise an entire logical block or a compressed logical block, for example. The main area of the log is used for storing an initial state of extent of logical blocks.

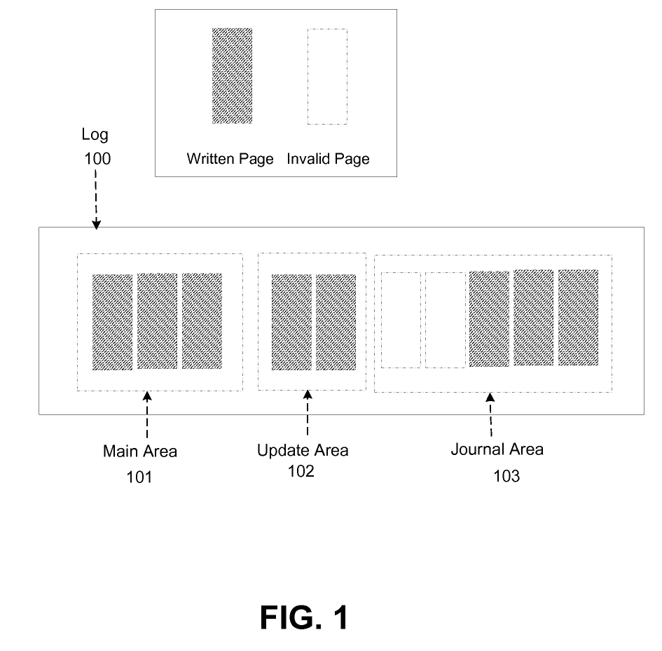

With regard to FIG. 1, an exemplary segment's log 100 comprising Main Area 101, Update Area 102, and Journal Area 103 is depicted according to embodiments of the present invention. Main Area 101 comprises data with a low probability of containing invalid logical blocks. Data truncation operations may cause logical block invalidation in Main Area 101. Main Area 101 may be considered the most important area for garbage collection activity. Updated data of logical blocks in Main Area 101 are stored in Updates area 102.

Updates Area 102 also comprises data with a low probability of containing invalid logical blocks. The Updates area stores updates of logical blocks of Main Area 101. File updates may cause logical block invalidation in Updates Area 102. Very frequent updates may be placed in a page cache before flushing data onto a volume. Updates Area 102 helps prevent fragmentation of data extents in the Main Area. Placing updated data into Updates Area 102 means that extents in Main Area 101 are not interrupted because of possible updates for extent's internal logical blocks. As a result, the unity of the extent from Main Area 101 is preserved when moving the extent during garbage collection.

Journal Area 103 comprises data with a very high probability of invalid logical blocks. Journal Area 103 may also comprise valid logical blocks, but the amount of valid logical blocks is typically very low because the data stored in Journal area is considered hot (frequently updated). Journal area 103 will be completely invalidated before garbage collection operations which improves efficiency of the garbage collection policy.

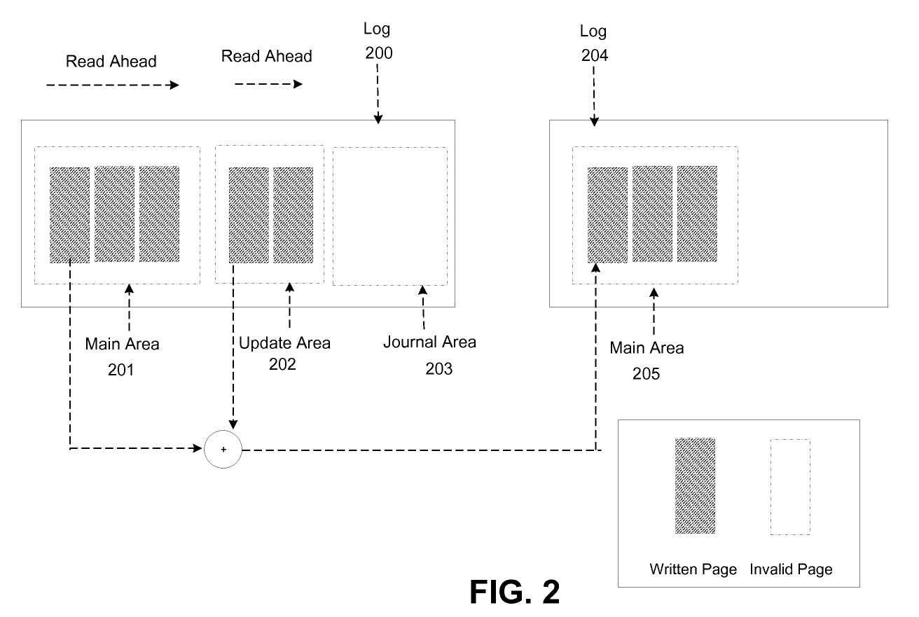

With regard to FIG. 2, an exemplary segment's log 204 for writing updated data from a Main area 201 and an Update area 202 of an exemplary aged segment's log 200 is depicted according to embodiments of the present invention. If logical block was been updated then it needs to move logical block from Update area, otherwise, it needs to move logical block from Main area. The whole updated logical block is stored in the Update area. The logical block may be saved as a compressed updated logical block. The use of a Main area, Updates area, and Journal area in the segment's logs greatly simplifies garbage collection and makes garbage collection far more efficient. A read-ahead technique can be used for reading a log into a buffer in DRAM. The state of every logical block is analyzed and operations are performed depending on a state of the logical blocks. A new log is constructed in main memory, and subsequently the log is written into flash memory.

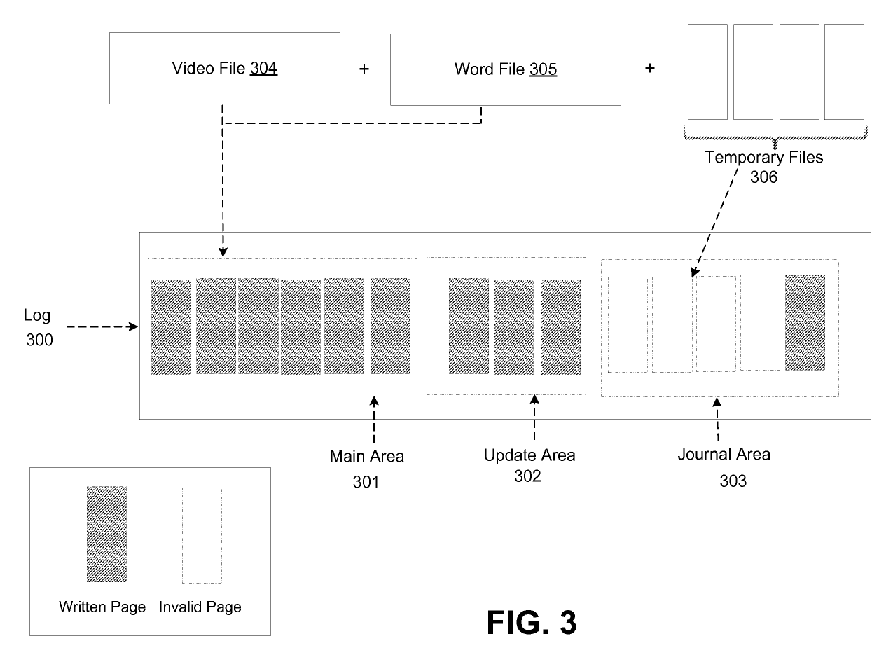

With regard to FIG. 3, an exemplary segment's log 300 for storing mixed-workload data (e.g., a video file and a word document) is depicted according to embodiments of the present invention. Contiguous extents of cold data (e.g., an initial file state) of Video File 304 and Word File 305 are written to Main Area 301 of segment's log 300. Updated logical blocks of Word file 305 are placed into a new log in the Updates Area 302. Logical blocks of temporary files 306 are placed in Journal Area 303. The temporary files are typically deleted at a later time and logical blocks of temporary files in the Journal area will be invalidated. Using Main, Updates, and Journal areas enables garbage collection that is independent from workload type and significantly simplifies garbage collection.

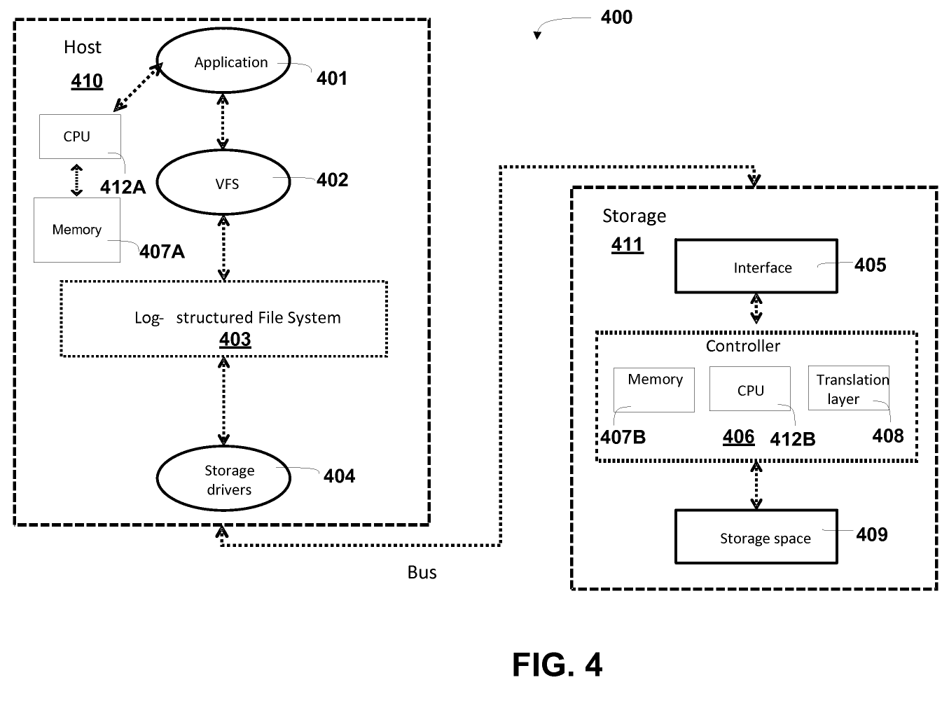

FIG. 4 illustrates an exemplary computer system 400 for managing a flash-based storage system and performing garbage collection operations. Host 410 is communicatively coupled to Storage 411 using a bus, for example. Application 401 running on Host 410 is a user-space application and may comprise any software capable of initiating requests for storing or retrieving data from a persistent storage device. Application 401 communicates with Virtual File System Switch (VFS) 402, a common kernel-space interface that defines what file system will be used for requests from user-space applications (e.g., application 401). Log structured file system 403 is maintained on Host 210 for storing data using storage drivers 404. Storage drivers 404 may comprise a kernel-space driver that converts a file system's (or block layer's) requests into commands and data packets for an interface that is used for low-level interaction with a storage device (e.g., storage 411). Memory 407A comprises DRAM and stores volatile data. The DRAM is used to construct segments' logs to be written to storage space 409.

Storage 411 comprises an interface for enabling low-level interactions (physically and/or logically) with storage device 411. For example, the interface may utilize SATA, SAS, NVMe, etc. Usually every interface is defined by some specification. The specification strictly defines physical connections, available commands, etc. Storage 411 further comprises a controller 406 optionally having a memory 407B and a translation layer 408. In the case of SSDs, the translation layer may comprise a FTL (Flash Translation Layer). Typically an FTL is on the SSD-side, but it can also be implemented on the host side. The goals of FTL are: (1) map logical numbers of NAND flash blocks into physical ones; (2) garbage collection; and (3) implementing wear-leveling. Data is written to and read from storage space 409 using controller 406. According to some embodiments, System 400 further comprises CPU 412A and/or CPU 412B. CPU 412A of Host 410 performs garbage collection operations on storage space 409 using controller 406.

With regard to FIG. 5, an exemplary computer implemented process 550 for performing garbage collection in a flash-based storage device is depicted according to embodiments of the present invention. At step 500, the process determines if a pool of candidate PEBs contains used PEBs. If the pool does not have any PEB candidates for garbage collection, the garbage collection process is unnecessary and the process ends. If the pool does contain used PEBs, a victim PEB is identified for garbage collection at step 501. The process continues to step 502 and determines if the PEB comprises only invalid data. If the PEB only contains invalid data, at step 504, a PEB erase operation is performed and the PEB is added to a pool of clean PEBs at step 505.

If at step 502 it is determined that the PEB contains both valid and invalid data, the process continues to step 503 where it is determined if all logs have been read. If so, a PEB erase operation is performed at step 504 and the PEB is added to a pool of clean PEBs at step 505. At step 503, if all logs have not been read, the PEB's log is read at step 506. At step 507, it is determined if the Main area contains valid data. If so, at step 508, the process 550 determines if the logical block has been updated. If the logical block has been updated, at step 509, a valid logical block is moved from the Update area to a Main area of a different log. If the logical block has not been updated, at step 510, a valid logical block is moved from the Main area to the Main area of a different log. The process 550 continues to step 511, where the process determines if the Journal area contains valid data. If so, at step 512, a valid logical block is moved from the Journal area to a Journal area of a different log. The Journal area stores small files and temporary files. Temporary files will be deleted frequently which results in invalid blocks in the Journal area. Several small files can be compacted into one NAND flash page of a Journal area. These files may grow in size over time, and updated small files may be moved into another log. This will invalidate blocks in the Journal area of the old log or logs. The process 550 returns to step 503 and continues until all logs have been read.

Embodiments of the present invention are thus described. While the present invention has been described in particular embodiments, it should be appreciated that the present invention should not be construed as limited by such embodiments, but rather construed according to the following claims.

What is claimed is:

1. A method of reusing an aged flash block in a flash-based storage system, comprising:
identifying a used physical erase block in a pool of physical erase blocks;
determining an optimal physical erase block to be reused based on predefined criteria, wherein the optimal physical erase block comprises a used physical erase block;
reading a log of the optimal physical erase block;
moving a first valid logical block from an updates area of the log to a different main area of a different log when the logical block has been updated and the updates area comprises valid data;
moving the first valid logical block from a main area of the log to the different main area of the different log when the logical block has not been updated and the main area comprises valid data; and
moving a second valid logical block from a journal area of the log to a different journal area of the different log when the journal area comprises valid data.

2. The method of claim 1, further comprising performing an erase operation on the optimal physical erase block to produce an erased optimal physical erase block and adding the erased optimal physical erase block to a pool of clean physical erase blocks.

3. The method of claim 1, wherein the process is repeated until all logs of the optimal physical erase block have been read.

4. The method of claim 1, wherein the main area comprises content that is rarely updated, the updates area comprises content that is frequently updated, and the journal area comprises data that is relatively small and is frequently updated.

5. The method of claim 1, wherein the flash-based storage system comprises NAND flash.

6. The method of claim 1, wherein the main area comprises read-only data.

7. The method of claim 1, further comprising updating metadata information associated with the log.

8. An apparatus for reusing an aged flash block in a flash-based storage system, comprising:
a flash memory device;
a main memory; and
a processor communicatively coupled to the flash memory device and the main memory that identifies a used physical erase block in a pool of physical erase blocks on the flash memory device, determines an optimal physical erase block for reusing based on predefined criteria, wherein the optimal physical erase block comprises a used physical erase block, reads a log of the optimal physical erase block, moves a first valid logical block from an updates area of the log to a different main area of a different log when the logical block has been updated and the updates area comprises valid data, moves the first valid logical block from a main area of the log to the different main area of the different log when the logical block has not been updated and the main area comprises valid data, and moves a second valid logical block from a journal area of the log to a different journal area of the different log when the journal area comprises valid data.

9. The apparatus of claim 8, wherein the processor performs an erase operation on the optimal physical erase block to produce an erased optimal physical erase block and adds the erased optimal physical erase block to a pool of clean physical erase blocks.

10. The apparatus of claim 8, wherein all logs of the optimal physical erase block have are read.

11. The apparatus of claim 8, wherein first main area comprises content that is rarely updated, the first updates area comprises content that is frequently updated, and the first journal area comprises data that is relatively small and is frequently updated.

12. The apparatus of claim 8, wherein the flash-based storage system comprises NAND flash and the different log is constructed in the main memory.

13. The apparatus of claim 8, wherein the main area comprises read-only data.

14. The apparatus of claim 8, further comprising updating metadata information associated with the log.

15. A computer program product tangibly embodied in a computer-readable storage device and comprising instructions that when executed by a processor perform a method for reusing an aged flash block of a flash memory device, the method comprising:
identifying a used physical erase block in a pool of physical erase blocks;
determining an optimal physical erase block to be reused based on predefined criteria, wherein the optimal physical erase block comprises a used physical erase block;
reading a log of the optimal physical erase block;
moving a first valid logical block from an updates area of the log to a different main area of a different log when the logical block has been updated and the updates area comprises valid data;
moving the first valid logical block from a main area of the log to the different main area of the different log when the logical block has not been updated and the main area comprises valid data; and
moving a second valid logical block from a journal area of the log to a different journal area of the different log when the journal area comprises valid data.

16. The method of claim 15, wherein the processor performs an erase operation on the optimal physical erase block to produce an erased optimal physical erase block and adds the erased optimal physical erase block to a pool of clean physical erase blocks.

17. The method of claim 15, wherein the process is repeated until all logs of the optimal physical erase block have been read.

18. The method of claim 15, wherein the main area comprises content that is rarely updated, the updates area comprises content that is frequently updated, and the journal area comprises data that is relatively small and is frequently updated.

19. The method of claim 15, wherein the flash-based storage system comprises NAND flash.

20. The method of claim 15, further comprising updating metadata information associated with the log.
